(19) United States
(12) Patent Application Publication
(10) Pub. No.: US 2008/0082624 A1
(43) Pub. Date: Apr. 3, 2008

(54) Portable storage device with audio auto-playback function and operation procedure thereof

(75) Inventor: Chih-Ling Wang, Chutung Town (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: PHISON ELECTRONICS CORP., Chutung Town (TW)

(21) Appl. No.: 11/528,649

(22) Filed: Sep. 28, 2006

(51) Int. Cl. G06F 15/16

(52) U.S. Cl. 709/217

(57) ABSTRACT

A portable storage device with audio auto-playback function and the operation procedure thereof is disclosed. The portable storage device is connected to a host end and can play audio data. The portable storage device comprises a memory block. The memory block comprises a ROM, a hidden sector and a rewritable sector. The ROM is an integrated circuit and comprises an auto-executing program for recalling another program in the memory block. The hidden sector is adopted for storing marked data to match with system data of the host end. The rewritable sector comprises audio data in a specific directory and the audio data can be deleted, and a matching program.

### BACKGROUND OF THE INVENTION

1. Field of the Invention

The present invention generally relates to a portable storage device with audio auto-playback function and operation procedure thereof, and more particularly to a portable storage device having an auto-executing program for initializing a matching program to match marked data with system data of a host end, and playing the audio data through an audio output of the host end or a built-in speaker of the portable storage device.

2. Description of Related Art

The memory devices available on the market are DRAM, SRAM, synchronous DRAM or flash memory. Among the above memory devices, flash memory is presently being rapidly developed and very popularly applied in personal computer. Recently, some manufacturers develop the flash memory with a larger storage capacity and are popularly applied in portable ROM, MP3 player and multi media player.

Conventionally, no notification message is provided when data is being transmitted from the host end to the portable storage devices, namely multi-media player, portable disk or MP3 player with the flash memory card. Thus, it is difficult for the user to learn the status of the portable storage devices.

The latest multi-media player, portable disk or MP3 player with flash memory card comprises a light-emitting diode monitor for displaying such as transmission date, time, file size or remaining memory capacity available after the transmission of the data. However, the above conventional devices have passive interaction with the user, and the user has to pay attention to the transmission status between the host end and the portable storage device. Therefore, it is inconvenient to the user.

Therefore, how to overcome the above defect is an important issue for the manufacturers in the field.

### SUMMARY OF THE INVENTION

Accordingly, in the view of the foregoing, the present invention provides a portable storage device comprising a matching program for matching marked data with system data of a host end, and the matched audio data may be played through an audio output of a host end or a built-in speaker of the portable storage device. Thus, the user need not pay attention to the transmission status between the host end and the portable storage device. Furthermore, because an LED monitor is not required in the portable storage device of the present invention, therefore the overall cost of the portable storage device may be substantially reduced.

According to an aspect of the present invention, by matching the marked data, for example by matching the birthday day of the user with the system data, for example the system date, the portable storage device can play the audio data, for example Happy Birthday Song, and thus add value to the entertainment feature of the portable storage device.

### BRIEF DESCRIPTION OF THE DRAWING

FIG. 1 is a block diagram of a portable storage device according to an embodiment of the present invention.

FIG. 2 is a flowchart illustrating an operation procedure of a portable storage device according to an embodiment of the present invention.

FIG. 3 is a flowchart illustrating an operation procedure of a portable storage device according to another embodiment of the present invention.

### DETAIL DESCRIPTION OF THE INVENTION

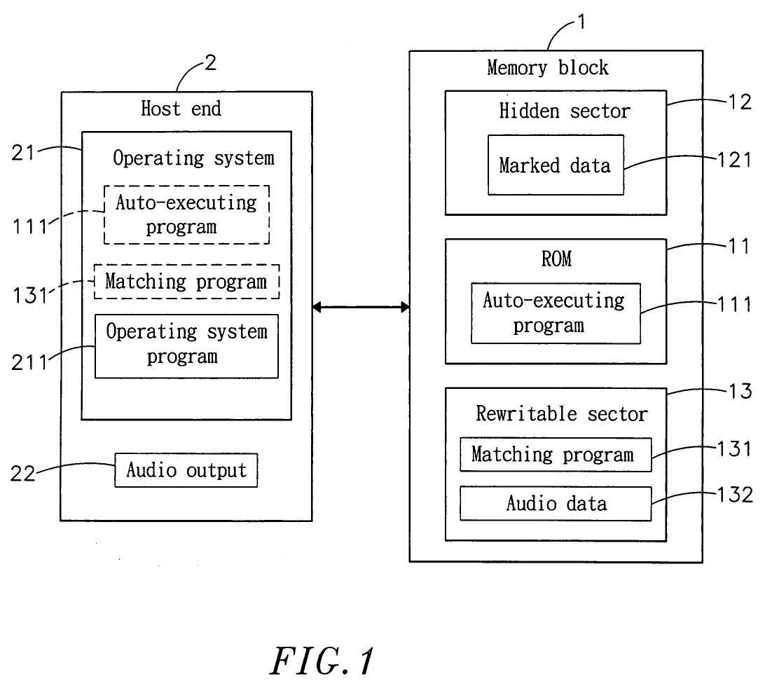

Referring to FIG. 1, a memory block 1 of the present invention comprises a ROM (Read Only Memory) 11, a hidden sector 12 and a rewritable sector 13. The memory block 1 may be built in a portable disk, a MP3 player or a multi-media player. Taking the memory block 1 is built in the portable disk as the example, and the feature of the embodiment of the present invention is described as follows.

The ROM 11 is an integrated circuit with memory function and can only read out data stored therein, and even when the power supply to the ROM 11 is cut off, the data stored in the ROM 11 can still be reservation. The ROM 11 comprises an auto-executing program 111 capable of initializing certain programs stored in the memory block 1. The hidden sector 12 is adopted for storing marked data 121, for example a specific data (a user's birthday), time, file size or numbers. The rewritable sector 13 is adopted for storing a specific audio data 132 in a specific directory. The audio data 132 in the specific directory can be deleted, replaced or changed according to the requirement of the user. Furthermore, the rewritable sector 13 also comprises a matching program 131. When the auto-executing program 111 of the ROM 11 is initialized, the matching program 131 may match data in a host end 2, for example date, time, file information, program executing signal or system information.

The above audio data 132 of the rewritable sector 13 may include speech, tone, music or the like for indicating or entertaining the user. The format of the audio data 132 may be ADPCM, MIDI, MP3, WAVE or any equivalent format shall be construed to be within the scope of the present invention.

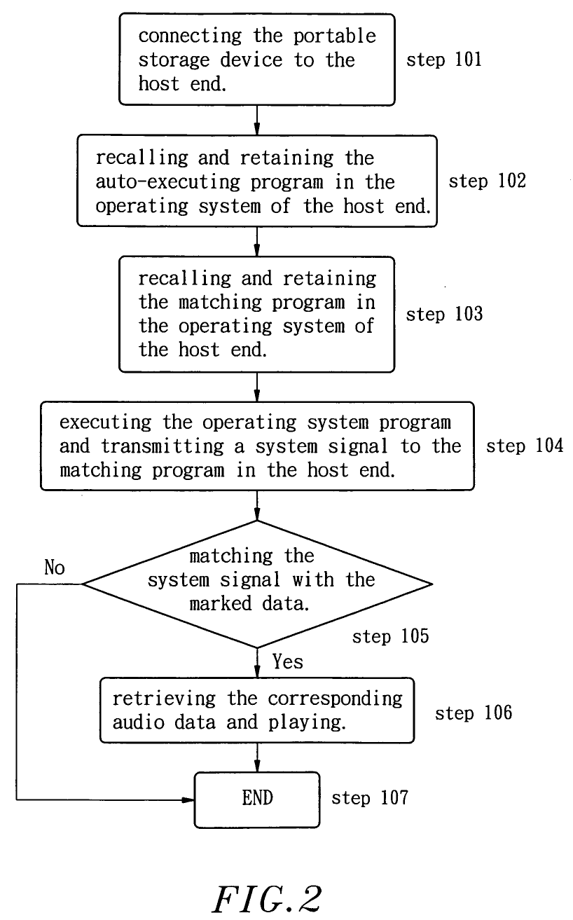

Referring to FIG. 1 and 2, the operation procedure for the portable storage device of the present invention interacting with the host end 2 is described as follows.

At step 101, the portable storage device is connected to the host end 2, and then the procedure proceeds to step 102.

At step 102, the host 2 recalls the auto-executing program 111 of the ROM 11 in the memory block 1, and the auto-executing program 11 is retained in an operating system 21 of the host end 2, and the procedure proceeds to step 103.

At step 103, the auto-executing program 111 retained in the operating system 21 of the host end 2 recalls the matching program 131 of the rewritable sector 13 in the memory block 1, and the matching program 131 is retained in the operating system 21 of the host end 2, and the procedure proceeds to step 104.

At step 104, the user executes an operating system program 211 built-in the operating system 21 of the host end 2, for example the file manager, and after the operating system program 211 executing completely, a system signal is transmitted to the matching program 131 retained in the operating system 21 of the host end 2, and the procedure proceeds to step 105.

At step 105, the matching program 131 retained in the host end 2 matches the system signal transmitted from the operating system program 211 with the marked data 121 in the hidden sector 12 of the memory block 1, wherein if the system signal matches with marked data 121, the procedure proceeds to step 106, otherwise the procedure proceeds to step 107.

At step 106, the matching program 131 retrieves the corresponding audio data 132 stored in the rewritable sector 13, and the audio data 132 is played by an audio output 22 of the host end 2 or a built-in speaker of the portable storage device, and then the procedure proceeds to step 107.

At step 107, ending the operation procedure.

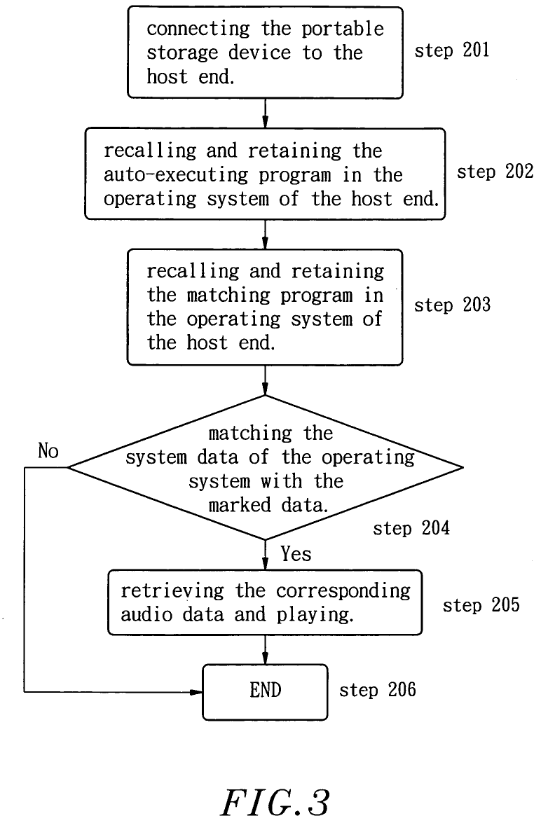

Referring to FIG. 1 and 3, an operation procedure for matching the marked data 121 in the portable storage device with system data of the host end 2 is described as follows.

At step 201, the portable storage device is connected to the host end 2, and the procedure proceeds to step 202.

At step 202, the host end 2 recalls the auto-executing program 111 of the ROM 11 in the memory block 1, and the auto-executing program 11 is retained in the operating system 21 of the host end 2, and then the procedure proceeds to step 203.

At step 203, the auto-executing program 111 in the operating system 21 recalls the matching program 131 of the rewritable sector 13 in the memory block 1, and the matching program 131 is retained in the operating system 21 of the host end 2, and then the procedure proceeds to step 204.

At step 204, the matching program 131 matches the system data of the operating system 21 with the marked data 121 in the hidden sector 12 of the memory block 1, wherein if the system data of the operating system 21 matches with the marked data 121, the procedure proceeds to step 205, otherwise the procedure proceeds to step 206.

At step 205, the matching program 131 retrieves the corresponding audio data 132 in the rewritable sector 13, and the audio data 132 is played by the audio output 22 of the host end 2 or the built-in speaker of the portable storage device, and then the procedure proceeds to step 206.

At step 206, end the operation procedure.

The host end 2 may be a personal computer, a notebook computer, a PDA or any other equivalent electronic device with an operating system construed to be within the scope of the present invention.

It should be noted that the important feature of the present invention is to divide the memory block 1 of the portable storage device into a ROM 11, a hidden sector 12 and a rewritable sector 13, wherein the rewritable sector 13 comprises a matching program 131 adopted to match a system signal generated by the operating system program 211 with the marked data 121 of the hidden sector 12, and the corresponding audio data 132 is played by the host end 2 or the built-in speaker of the portable storage device. Accordingly, the present invention has at least the following advantages.

1. The portable storage device of the present invention and the host end 2 interact with the user actively in a manner that the user need not pay attention to the transmission or operation status of the host end 2 and the portable storage device. Furthermore, because an LED monitor is not required in the portable storage device of the present invention, therefore the overall cost of the portable storage device may be substantially reduced.

2. The marked data 121, such as user's birthday, may be matched with the system data, for example the system data, to retrieve and play the corresponding audio data 132, for example Happy Birthday Song to add more value and the entertainment.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A portable storage device with audio auto-playback function, wherein said portable storage device is connected with a host end and can play audio data, said portable storage device comprising:
a memory block comprising a ROM, a hidden sector and a rewritable sector;
wherein said ROM is an integrated circuit with memory function and comprises an auto-executing program for recalling another program in said memory block; said hidden sector is adopted for storing marked data to match with a system data of said host end; said rewritable sector is adopted for storing audio data in a specific directory that can be deleted, and a matching program adopted for matching said marked data with said system data of said host end.

2. The portable storage device with audio auto-playback function according to claim 1, wherein said memory block can be built in a portable stick, a MP3 player or a multi-media player.

3. The portable storage device with audio auto-playback function according to claim 1, wherein said host end can be a personal computer, a notebook computer or a PDA.

4. The portable storage device with audio auto-playback function according to claim 1, wherein said marked data of said hidden sector can be data, time, file information or program executing signals.

5. The portable storage device with audio auto-playback function according to claim 1, wherein said audio data in said specific directory of said rewritable sector can be speech, tone or music for indicating or entertaining a user, and a format of said audio data comprises ADPCM, MIDI, MP3 or WAVE.

6. The portable storage device with audio auto-playback function according to claim 1, wherein said audio data is played through a audio output of said host end or a built-in speaker of said portable storage device.

7. The portable storage device with audio auto-playback function according to claim 1, wherein said auto-execution program in said ROM can be retained in an operating system of said host end.

8. The portable storage device with audio auto-playback function according to claim 1, wherein said matching program of said rewritable sector can be retained in a operating system of said host end.

9. A method of operating a portable storage device with audio auto-playback function and a host end, comprising:
(a) connecting a portable storage device to a host end;
(b) recalling an auto-executing program of a ROM in a memory block, and retaining said auto-execution program in an operating system of said host end;
(c) recalling a matching program of a rewritable sector in said memory block, and retaining said matching program in said operating system of said host;
(d) executing an operating system program built-in said operating system of said host end, and transmitting a system signal to said matching program retained in said operating system of said host end;
(e) matching said system signal transmitted from said operating system program with marked data stored in a hidden sector of said portable storage device by said matching program retained in said operating system, wherein if said system signal does not match with said marked data in said hidden sector, proceed to step (g), and if said system signal matches with said marked data in said hidden sector in said hidden sector, proceed to step (f);
(f) retrieving corresponding audio data stored in said rewritable sector by said matching program retained in said operating system, and playing said audio data through an audio output of said host end or a built-in speaker of said portable storage device; and
(g) ending.

10. A method of operating a portable storage device with audio auto-playback function and a host end, comprising
(a) connecting a portable storage device to a host end;
(b) recalling an auto-executing program of a ROM in a memory block of said portable storage device, and retaining said auto-executing program in an operating system of said host end;
(c) recalling a matching program of a rewritable sector in said memory block, and retaining said matching program in said operating system of said host end;
(d) matching system data of an operating system program with marked data stored in a hidden sector of said portable storage device by said matching program retained in said operating system, wherein if the said system data does not match with said marked data, proceed to step (f), and if said system data matches with said marked data, proceed to step (e);
(e) retrieving corresponding audio data stored in said rewritable sector by said matching program retained in said operating system, and playing said audio data by an audio output of said host end or a built-in speaker of said portable storage device; and
(f) ending.
